(19) United States
(12) Patent Application Publication
(10) Pub. No.: US 2025/0034387 A1
(43) Pub. Date: Jan. 30, 2025

(54) SPRAY ADHESIVE COMPOSITION AND RELATED METHODS

(71) Applicant: 3M INNOVATIVE PROPERTIES COMPANY, St. Paul, MN (US)

(72) Inventors: Dillon S. Gentekos, St. Paul, MN (US); Lili Qie, Woodbury, MN (US); Kumars Sakizadeh, Woodbury, MN (US); Michael D. Zenner, Hudson, WI (US); Ying Zhang, Woodbury, MN (US)

(21) Appl. No.: 18/715,465

(22) PCT Filed: Dec. 8, 2022
(86) PCT No.: PCT/IB2022/061934

§ 371 Date: May 31, 2024

Related U.S. Application Data
(60) Provisional application No. 63/287,258, filed on Dec. 8, 2021.

(51) Int. Cl. C08L 33/06; B05D 1/02; B05D 5/10; C08F 2/26; C08F 220/18; C09J 5/00; C09J 7/10; C09J 7/38; C09J 133/06

(52) U.S. Cl. CPC C08L 33/066; B05D 1/02; B05D 5/10; C08F 2/26; C08F 220/1812; C09J 5/00; C09J 7/10; C09J 7/385; C09J 133/066; B05D 2203/00; B05D 2401/21; B05D 2502/00; B05D 2507/00; C08L 2201/52; C08L 2205/035; C09J 2400/263; C09J 2433/00

(57) ABSTRACT

A composition includes an acrylic polymer, an emulsifier, and water. The acrylic polymer includes monomer units of at least one alkyl acrylate or alkyl methacrylate, wherein alkyl has at least 8 carbon atoms. Not more than one percent by weight of monomer units include a carboxylic acid, sulfonic acid, or phosphonic acid, based on the total weight of monomer units in the acrylic polymer. The composition is an emulsion of the acrylic polymer in water. The composition is a spray adhesive composition and/or coagulates upon being subjected to shear forces. A process for making the composition and a method for making a bonded article using the composition are also described.

### CROSS-REFERENCE TO RELATED APPLICATION

This application claims priority to U.S. Provisional Application No. 63/287,258, filed Dec. 8, 2021, the disclosure of which is incorporated by reference in its entirety herein.

### BACKGROUND

Pressure-sensitive adhesives (often referred to as PSAs) are useful for a variety of purposes. Applying PSAs may involve applying an adhesive polymer composition in organic solvent or as an oil-in-water emulsion onto a substrate and subsequently removing the solvent or water. Water-based adhesives have significant advantages over their traditional solvent borne counterparts in that they can have low or no volatile organic compounds and can be nonflammable.

U.S. Pat. No. 9,624,408 (Pietsch et al.) and 10,662,263 (Schmidt et al.) disclose aqueous polymer dispersions that require thermoplastic microspheres containing a propellant for coagulation. U.S. Pat. No. 6,187,825 (Guntherberg et al.) discloses a process for continuous coagulation of aqueous dispersions of graft rubbers suitable for toughening thermoplastics. U.S. Pat. No. 10,221,343 (Qie et al.) discloses one-part, fast-setting, aqueous adhesive emulsions including a core-shell acrylic polymer.

### SUMMARY

The present disclosure provides a composition that includes an acrylic polymer in water. Instead of being sprayable as a fine mist in which the polymer particles require a long time to coalesce and develop pressure-sensitive adhesive (PSA) characteristics (e.g., tack), the composition of the present disclosure coagulates upon being subjected to shear forces, for example, upon being sprayed from a nozzle. Coagulation upon spraying allows the composition to quickly develop PSA characteristics, for example, within one minute of being applied to a substrate.

In one aspect, the present disclosure provides a spray adhesive composition that includes an acrylic polymer, an emulsifier, and water. The acrylic polymer includes monomer units of at least one alkyl acrylate or alkyl methacrylate, wherein alkyl has at least 8 carbon atoms. Not more than one percent by weight of monomer units include a carboxylic acid, sulfonic acid, or phosphonic acid, based on the total weight of monomer units in the acrylic polymer. The spray adhesive composition is an emulsion of the acrylic polymer in water.

In another aspect, the present disclosure provides a composition that includes an acrylic polymer, an emulsifier, and water. The acrylic polymer includes monomer units of at least one alkyl acrylate or alkyl methacrylate, wherein alkyl has at least 8 carbon atoms. Not more than one percent by weight of monomer units include a carboxylic acid, sulfonic acid, or phosphonic acid, based on the total weight of monomer units in the acrylic polymer. The composition is an emulsion of the acrylic polymer in water. The composition coagulates upon being subjected to shear forces, for example, in a spray nozzle.

In some embodiments of the aforementioned aspects, the composition is packaged in a spray container. Advantageously, the composition is not coagulated inside the spray container. In some embodiments, advantageously, the emulsion coagulates upon being sprayed from the spray container. In some embodiments, the composition includes a tackifier. In some embodiments, alkyl (in the alkyl acrylate or methacrylate) has at least 10, 11, or 12 carbon atoms. In some embodiments, the acrylic polymer is free of monomer units including a carboxylic acid, sulfonic acid, or phosphonic acid. In some embodiments, the acrylic polymer is a nonionic polymer.

In another aspect, the present disclosure provides a process for making the composition. The process includes combining a tackifier and the at least one alkyl acrylate or alkyl methacrylate to form a solution, combining the solution with the water and the emulsifier, and polymerizing the at least one alkyl acrylate or alkyl methacrylate to form an emulsion with droplets that include both the acrylic polymer and the tackifier.

In another aspect, the present disclosure provides a process for making a bonded article that includes a first substrate or a second substrate. The process includes spraying the aforementioned composition on at least one of the first substrate or the second substrate and adhering the first substrate and the second substrate together. In some embodiments, the composition coagulates upon spraying to form an adhesive. In some embodiments, the adhesive is tacky within one minute after spraying.

The ability of composition to coagulates upon being subjected to shear forces, for example, upon spraying, can be determined using the Time to Hold and/or Instant Tack and Hold evaluations described herein.

In this application, terms such as “a”, “an” and “the” are not intended to refer to only a singular entity but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated (e.g., 1 to 5 includes 1, 1.5, 2, 2.75, 3, 3.8, 4, and 5, and the like).

The terms “first” and “second” are used in this disclosure in their relative sense only. It will be understood that, unless otherwise noted, those terms are used merely as a matter of convenience in the description of one or more of the embodiments.

As used herein, the term “acrylic” or “acrylate” includes compounds having at least one of acrylic or methacrylic groups.

The term “(meth)acrylate” with respect to a monomer, oligomer or polymer means a vinyl-functional alkyl ester formed as the reaction product of an alcohol with an acrylic or a methacrylic acid.

The term “(co)polymer” or “(co)polymeric” includes homopolymers and copolymers, as well as homopolymers or copolymers that may be formed in a miscible blend, e.g., by coextrusion or by reaction, including, e.g., transesterification. The term “copolymer” includes random, block, graft, and star copolymers.

The term “crosslinking” refers to joining polymer chains together by covalent chemical bonds, usually via crosslinking molecules or groups, to form a network polymer. A crosslinked polymer is generally characterized by insolubility but may be swellable in the presence of an appropriate solvent.

“Alkyl group” and the prefix “alk-” are inclusive of both straight chain and branched chain groups and of cyclic groups. In some embodiments, alkyl groups have up to 30 carbons (in some embodiments, up to 25, 20, 18, 16, or 15 carbons) unless otherwise specified. Cyclic groups can be monocyclic or polycyclic. Alkyl groups are not fluorinated or perfluorinated.

The term “hydrocarbon” refers to compounds that have only carbon and hydrogen atoms.

PSAs are well known to those of ordinary skill in the art to possess properties including the following: (1) aggressive and permanent tack, (2) adherence with no more than finger pressure, (3) sufficient ability to hold onto an adherend, and typically, (4) sufficient cohesive strength to be cleanly removable from the adherend. PSAs are tacky and have the ability to adhere without activation by any energy source such as light, heat, or a chemical reaction. Materials that have been found to function well as PSAs are polymers designed and formulated to exhibit the requisite viscoelastic properties resulting in a desired balance of tack, peel adhesion, and shear holding power. One method useful for identifying pressure sensitive adhesives is the Dahlquist criterion. This criterion defines a pressure sensitive adhesive as an adhesive having a creep compliance of greater than 3×10⁻⁶ cm²/dyne as described in Handbook of Pressure Sensitive Adhesive Technology, Donatas Satas (Ed.), 2nd Edition, p. 172, Van Nostrand Reinhold, New York, NY, 1989. Alternatively, since modulus is, to a first approximation, the inverse of creep compliance, pressure sensitive adhesives may be defined as adhesives having a storage modulus of less than about 3×10⁵ N/m².

The above summary of the present disclosure is not intended to describe each disclosed embodiment or every implementation of the present disclosure. The description that follows more particularly exemplifies illustrative embodiments. It is to be understood, therefore, that the following description are for illustration purposes only and should not be read in a manner that would unduly limit the scope of this disclosure.

### DETAILED DESCRIPTION

In aqueous based acrylic adhesives, acrylic acid and methacrylic acid have been used to improve adhesion performance in shear and peel. As a relative low percentage of the monomers in an acrylic polymer, acrylic acid and methacrylic acid can provide significant strength enhancements without significantly increasing the glass transition temperature (T_{g}) of the polymer, allowing the adhesives to remain tacky while also being cohesively strong. Acrylic acid and methacrylic acid also tend to improve the shear stability of an acrylic emulsion, which makes roll or knife coating these adhesives facile and enables them to spray in a finely atomized mist for thin spray coatings. In these cases, time is required to allow the adhesive/polymer particles to interact and coalesce before they become tacky enough for substrate bonding.

In this regard, one of the major disadvantages of using water-based adhesives in sprayable applications is that water takes a significantly longer time to evaporate compared to common organic solvents used in solvent-based adhesives. This low drying efficiency greatly increases the amount of time required (e.g., up to 30 minutes or more in some cases) for the adhesive to dry before the operator can bond substrates together; organic solvent-based spray adhesive require just a few seconds or minutes for drying.

We now describe compositions and methods that allow water-based adhesives to compete with the short drying times of solvent-based adhesives. Although this disclosure is not intended to be bound by any theory, in the new compositions and methods an adhesive emulsion can coagulate upon exposure to shear forces (e.g., spraying), producing coalesced adhesive particles before even hitting the substrate, thereby eliminating the time required to allow particles to coalesce before becoming tacky and allowing an adhesive bond to be made immediately after spraying.

Acrylic polymers useful in the compositions and methods of the present disclosure include monomer units of at least one alkyl acrylate or alkyl methacrylate, in which alkyl has at least 8 carbon atoms. In some embodiments, alkyl has at least 10, 11, or 12 carbon atoms. Examples of suitable alkyl (meth)acrylates include those represented by Formula I:

$${CH}_{2} = C ( {R}^{′} ) COO R \qquad ( I )$$

wherein R′ is hydrogen or a methyl group and R is an alkyl group having 8 to 30, 10 to 30, 12 to 30, 8 to 20, 10 to 20, 12 to 20, 10 to 18, 12 to 18, 10 to 16, or 12 to 16 carbon atoms and may be linear, branched, cyclic, or polycyclic. Examples of suitable monomers represented by Formula I include 2-ethylhexyl acrylate, n-octyl acrylate, 2-octyl acrylate, isooctyl acrylate, n-nonyl acrylate, isononyl acrylate, n-decyl acrylate, isodecyl acrylate, n-dodecyl acrylate, isomyristyl acrylate, n-tridecyl acrylate, n-tetradecyl acrylate, stearyl acrylate, isostearyl acrylate, isobornyl acrylate, octadecyl acrylate, behenyl acrylate, and methacrylates of the foregoing acrylates. Suitable monomer units further include mixtures of at least two or at least three structural isomers of a secondary alkyl (meth)acrylate of Formula II:

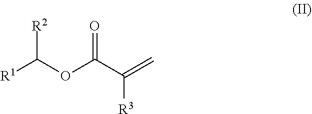

wherein R¹ and R² are each independently a C₁ to C₃₀ saturated linear alkyl group; the sum of the number of carbons in R¹ and R² is 7 to 31; and R³ is H or CH₃. The sum of the number of carbons in R¹ and R² can be, in some embodiments, 7 to 27, 7 to 25, 7 to 21, 7 to 17, 7 to 11, 7, 11 to 27, 11 to 25, 11 to 21, 11 to 17, or 11. Methods for making and using such monomers and monomer mixtures are described in U.S. Pat. No. 9,102,774 (Clapper et al.). In general, acrylates (as opposed to methacrylates) may be useful for providing PSA properties.

Mixtures of one or more monomers of Formula I, Formula II, or combinations of Formulas I and II may be useful for the acrylic polymer. In some embodiments, the acrylic polymer further comprises monomer units of a second monomer comprising at least one of a C₄-C₉ alkyl acrylate or C₄-C₉ alkyl methacrylate, in some embodiments, a C₄-C₉ alkyl acrylate. Suitable C₄-C₉ alkyl (meth)acrylates include hexyl acrylate, cyclohexylacrylate, norbornyl acrylate, heptyl acrylate, 2-ethylhexyl acrylate, n-octyl acrylate, 2-octyl acrylate, isooctyl acrylate, n-nonyl acrylate, isononyl acrylate, isobornyl acrylate, methacrylates of the foregoing acrylates, and combinations thereof. In some embodiments, the second monomer is a C₆-C₉ alkyl (meth)acrylate or a C₆-C₈ alkyl (meth)acrylate. In some embodiments in which the acrylic polymer includes monomer units of a second monomer, at least one of the alkyl acrylate or alkyl methacrylate (e.g., of Formula I or II) has at least 10, 11, or 12 carbon atoms.

Not more than one percent by weight of monomer units in the acrylic polymer useful in the compositions and methods of the present disclosure include a carboxylic acid, sulfonic acid, or phosphonic acid. Monomers that have carboxylic acid, sulfonic acid, or phosphonic acid groups include acrylic acid, methacrylic acid, itaconic acid, maleic acid, fumaric acid, ethacrylic acid, crotonic acid, citraconic acid, cinnamic acid, beta-carboxy ethyl acrylate, 2-methacrylolyloxyethyl succinate, 2-acrylamido-2-methylpropane sulfonic acid, and vinyl phosphonic acid. Monomers units including a carboxylic acid, sulfonic acid, or phosphonic acid encompasses salts of these acids, such as alkali metal salts and ammonium salts. In some embodiments, not more than 0.5, 0.25, 0.1, 0.05, or 0.01 percent by weight of monomer units in the acrylic polymer useful in the compositions and methods of the present disclosure include a carboxylic acid, sulfonic acid, or phosphonic acid. In some embodiments, the acrylic polymer is free of monomer units comprising a carboxylic acid, sulfonic acid, or phosphonic acid. We have found that emulsions of acrylic polymers having not more than one percent by weight of monomer units in the acrylic polymer bearing carboxylic acid, sulfonic acid, and phosphonic acid groups can have greatly reduced shear stability and coagulate upon being subjected to shear forces such as those induced in a spray nozzle.

In some embodiments, not more than one percent by weight of monomer units in the acrylic polymer useful in the compositions and methods of the present disclosure include a cationic quaternary amine, such as DMAEA-MCL (N,N-dimethylaminoethyl acrylate methyl chloride quaternary, such as that obtained under the trade designation “AGEFLEX FA1Q80MC” from BASF SE, Ludwigshafen, Germany as an 80% solution in water). In some embodiments, not more than 0.5, 0.25, 0.1, 0.05, or 0.01 percent by weight of monomer units in the acrylic polymer useful in the compositions and methods of the present disclosure include a cationic quaternary amine. In some embodiments, the acrylic polymer is free of monomer units comprising a cationic quaternary amine. In some embodiments, the acrylic polymer is a nonionic polymer. Nonionic polymers include no anionic groups such as carboxylic acid, sulfonic acid, or phosphonic acid groups and salts thereof or cationic groups such as quaternary amines.

In some embodiments, the acrylic polymer further comprises monomer units of a “high T_{g}” monomer that when polymerized provides a homopolymer having a glass transition temperature (T_{g}) of at least 30° C., at least 40° C., or at least 50° C. when homopolymerized (i.e., a homopolymer formed from the monomer has a T_{g} at least 30° C., at least 40° C., or at least 50° C.). The T_{g} of the homopolymers are measured by Differential Scanning Calorimetry, and many are reported in the Polymer Properties Database found at polymerdatabase.com. Some suitable high T_{g} monomers have a single (meth)acryloyl group such as methyl methacrylate, ethyl methacrylate, n-propyl methacrylate, isopropyl methacrylate, n-butyl methacrylate, isobutyl methacrylate, sec-butyl methacrylate, tert-butyl (meth)acrylate, cyclohexyl methacrylate, isobornyl (meth)acrylate, stearyl (meth)acrylate, phenyl acrylate, benzyl methacrylate, 3,3,5 trimethylcyclohexyl (meth)acrylate, tert-butyl cyclohexyl methacrylate, 2-phenoxyethyl methacrylate, N-octyl (meth)acrylamide, tetrahydrofurfuryl methacrylate, and mixtures thereof. Other suitable high T_{g} monomers have a single vinyl group that is not a (meth)acryloyl group such as various vinyl ethers (e.g., vinyl methyl ether), vinyl esters (e.g., vinyl acetate and vinyl propionate), styrene, substituted styrene (e.g., α-methyl styrene), vinyl halide, and mixtures thereof.

In some embodiments, the acrylic polymer further comprises monomer units of a polar monomer including at least one ketone, amide, amine, alcohol or combination thereof. Examples of polar monomers with a hydroxyl group include hydroxyalkyl (meth)acrylates (e.g., 2-hydroxyethyl (meth)acrylate, 2-hydroxypropyl (meth)acrylate, 3-hydroxypropyl (meth)acrylate, and 4-hydroxybutyl (meth)acrylate), hydroxyalkyl (meth)acrylamides (e.g., 2-hydroxyethyl (meth)acrylamide or 3-hydroxypropyl (meth)acrylamide), ethoxylated hydroxyethyl (meth)acrylate (e.g., monomers commercially available from Sartomer (Exton, PA, USA) under the trade designation CD570, CD571, and CD572), and aryloxy substituted hydroxyalkyl (meth)acrylates (e.g., 2-hydroxy-2-phenoxypropyl (meth)acrylate). Examples of polar monomers with a primary amido group include (meth)acrylamide.

Examples of polar monomers with secondary amido groups include N-alkyl (meth)acrylamides such as N-methyl (meth)acrylamide, N-ethyl (meth)acrylamide, N-isopropyl (meth)acrylamide, N-tert-octyl (meth)acrylamide, and N-octyl (meth)acrylamide. Examples of polar monomers with a tertiary amido group include N-vinyl caprolactam, N-vinyl-2-pyrrolidone, (meth)acryloyl morpholine, and N,N-dialkyl (meth)acrylamides such as N,N-dimethyl (meth)acrylamide, N,N-diethyl (meth)acrylamide, N,N-dipropyl (meth)acrylamide, and N,N-dibutyl (meth)acrylamide. Polar monomers with an amino group include various N,N-dialkylaminoalkyl (meth)acrylates and N,N-dialkylaminoalkyl (meth)acrylamides. Examples include N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide. Examples of polar monomers that include ketones include diacetone acrylamide and acetoacetoxy ethyl methacrylate. In some embodiments, not more than 1, 0.5, 0.25, 0.1, 0.05, or 0.01 percent by weight of monomer units in the acrylic polymer useful in the compositions and methods of the present disclosure include at least one ketone, amide, amine, alcohol, or combination thereof. The acrylic polymer may be free of polar monomer units.

Crosslinked acrylic PSAs may be made, for example, by including one or more polyfunctional crosslinking monomers in the formulation. In some embodiments, the acrylic polymer further comprises monomer units of a multifunctional acrylate or multifunctional methacrylate. Suitable polyfunctional monomers include diacrylate esters of diols, such as ethylene glycol diacrylate, diethylene glycol diacrylate, propanediol diacrylate, butanediol diacrylate, butane-1,3-diyl diacrylate, pentanediol diacrylate, hexanediol diacrylate (including 1,6-hexanediol diacrylate), heptanediol diacrylate, octanediol diacrylate, nonanediol diacrylate, decanediol diacrylate, and dimethacrylates of any of the foregoing diacrylates. Further suitable polyfunctional monomers include polyacrylate esters of polyols, such as glycerol triacrylate, dipropylene glycol diacrylate, tripropylene glycol diacrylate, trimethylolpropane triacrylate, pentaerythritol tetraacrylate, neopentyl glycol diacrylate, dipentaerythritol pentaacrylate, methacrylates of the foregoing acrylates, and combinations thereof. Further suitable polyfunctional crosslinking monomers include divinyl benzene, allyl methacrylate, diallyl maleate, diallyl phthalate, and combinations thereof. Further suitable polyfunctional crosslinking monomers include polyfunctional acrylate oligomers comprising two or more acrylate groups. The polyfunctional acrylate oligomer may be a urethane acrylate oligomer, an epoxy acrylate oligomer, a polyester acrylate, a polyether acrylate, a polyacrylic acrylate, a methacrylate of any of the foregoing acrylates, or a combination thereof. Combinations of any of these crosslinking monomers may be useful. In some embodiments, not more than 1, 0.5, 0.25, 0.1, 0.05, or 0.01 percent by weight of monomer units in the acrylic polymer useful in the compositions and methods of the present disclosure are derived from crosslinking monomers. The acrylic polymer may be free of crosslinking monomer units.

In some embodiments, the acrylic polymer can contain up to 100 weight percent (e.g., 100 weight percent) of monomer units of at least one alkyl acrylate or alkyl methacrylate, in which alkyl has at least 8 carbon atoms as described above in any of its embodiments. The weight percent value is based on the total weight of monomeric units in the polymeric material. In some embodiments, the acrylic polymer contains 65 to 100 weight percent of monomer units of at least one alkyl acrylate or alkyl methacrylate, in which alkyl has at least 8 carbon atoms as described above in any of its embodiments, 0 to 5 weight percent polar monomeric units, 0 to 35 weight percent high T_{g} monomeric units, and 0 to 5 weight percent crosslinking monomeric units. In some embodiments, the acrylic polymer contains 80 to 100 weight percent of monomer units at least one alkyl acrylate or alkyl methacrylate, in which alkyl has at least 8 carbon atoms as described above in any of its embodiments, 0 to 2 weight percent polar monomeric units, 0 to 20 weight percent high T_{g} monomeric units, and 0 to 1 weight percent crosslinking monomer units. In some embodiments, the acrylic polymer contains 80 to 100 weight percent of monomer units at least one alkyl acrylate or alkyl methacrylate, in which alkyl has at least 8 carbon atoms as described above in any of its embodiments, 0 to 1 weight percent polar monomeric units, 0 to 20 weight percent high T_{g} monomeric units, and 0 to 0.5 weight percent crosslinking monomer units.

In some embodiments, the acrylic polymer in the emulsion of the acrylic polymer in water is not a core-shell polymer having different monomer compositions in the core and the shell. While polymerizations result in a distribution of compositions and molecular weights, the emulsion polymerization is, in some embodiments, not carried out so that the monomer composition is changed during the polymerization to provide polymer particles with cores having a different glass transition temperature or a different reactivity from the shell.

Depending on the amount of any of the tackifiers and other additives described below, in some embodiments, the composition or spray adhesive composition may include at least 70, 75, 80, 90, 95, 98, or 99 weight percent of the acrylic polymer described above in any of its embodiments, based on the total amount of solids in the composition (that is, excluding water).

In some embodiments, of the compositions and methods of the present disclosure, the composition or spray adhesive composition further comprises a tackifier. In some embodiments, the tackifier comprises at least one of rosin, a rosin ester, an ester of hydrogenated rosin, a polyterpene (e.g., those based on α-pinene, β-pinene, or limonene), an aliphatic hydrocarbon resin (e.g., those based on cis- or trans-piperylene, isoprene, 2-methyl-but-2-ene, cyclopentadiene, dicyclopentadiene, or combinations thereof), an aromatic resin (e.g. those based on styrene, α-methyl styrene, methyl indene, indene, coumarone, or combinations thereof), or a mixed aliphatic-aromatic hydrocarbon resin. The aromatic hydrocarbon resins may be C9-type petroleum resins obtained by copolymerizing a C9 fraction produced by thermal decomposition of petroleum naphtha, and aliphatic hydrocarbon resins may be C5-type petroleum resins obtained by copolymerizing a C5 fraction produced by thermal decomposition of petroleum naphtha. Mixed aliphatic/aromatic resins may be C5/C9-type petroleum resins obtained by polymerizing a combination of a C5 fraction and C9 fraction produced by thermal decomposition of petroleum naphtha. Any of these tackifying resins may be hydrogenated (e.g., partially, or completely). The term rosin, as employed herein, includes natural rosin, refined or unrefined (refined rosin will usually contain, by weight, about 90% of rosin acids and about 10% of inert material), such as natural wood rosin, natural gum rosin, and tall oil rosin; modified rosin, refined or unrefined, such as disproportionated rosin, hydrogenated rosin, and polymerized rosin; and the pure or substantially pure acids, of which rosin is comprised, alone or in admixture. In some embodiments, the tackifier is a hydrocarbon tackifier. In some embodiments, useful tackifiers can have a number average molecular weight of up to 10,000 grams per mole, a softening point of at least 30° C. as determined using a ring and ball apparatus, and a glass transition temperature of at least −30° C. as measured by differential scanning calorimetry. Useful tackifiers are typically amorphous. In some embodiments, the tackifier is miscible with the acrylic polymer of the composition or spray adhesive composition such that macroscopic phase separation does not occur in the composition. In some embodiments, a combination of tackifiers may be useful to obtain a good balance of compatibility and adhesive performance (e.g., high temperature performance).

Examples of suitable tackifiers include those obtained under the trade designations “FORAL 85E” (a glycerol ester of highly hydrogenated refined gum rosin) commercially available from Eastman, Middelburg, NL, “FORAL 3085” (a glycerol ester of highly hydrogenated refined wood rosin) commercially available from Pinova, Brunswick, GA; “ESCOREZ 2520” and “ESCOREZ 5615” (aliphatic/aromatic hydrocarbon resins) commercially available from ExxonMobil Corp., Houston, TX; “REGALITE 7100” (a partially hydrogenated hydrocarbon resin) commercially available from Eastman, Kingsport, Tennessee, and fully and partially hydrogenated hydrocarbon tackifiers obtained from Arakawa, Osaka, Japan, under the trade designation “ARKON”.

In some embodiments, the tackifier is present in the composition in a range from two parts to 30 parts by weight per one hundred parts of acrylic polymer. In some embodiments, the tackifier is present in a range from 2 to 25, 2 to 20, 5 to 25, 10 to 25, 10 to 20, 2 to 15, or 2 to 10 parts by weight per one hundred parts of the acrylic polymer.

The acrylic polymer useful in the compositions and methods of the present disclosure is conveniently prepared by emulsion polymerization. An acrylic monomer or combination of monomers as described above in any of their embodiments is combined with water and an emulsifier or combination of emulsifiers and then the monomer or monomers are polymerized. One or more of the monomers can be emulsified first in the stirred aqueous phase before initiation is begun. In some embodiments, the method of the present disclosure provides combining a tackifier and at least one alkyl acrylate or alkyl methacrylate, each as described above in any of their embodiments, to form a solution, combining the solution with the water and the emulsifier, and polymerizing the at least one alkyl acrylate or alkyl methacrylate in the presence of the tackifier. The many parameters of emulsion polymerization technique can be adjusted by those skilled in the art. For example, initiator can be added according to a variety of possible schedules, and monomers can be added continuously or in staggered increments. Additionally, a polymerization can be started in the presence of a previously prepared seed.

The emulsifier used in the emulsion polymerization is typically present in the composition or spray adhesive composition of the present disclosure. In some embodiments, the emulsifier used in the emulsion polymerization is an anionic surfactant. Useful anionic surfactants include those that include at least one hydrophobic moiety such as an about 6 carbon atom- to about 12 carbon atom-alkyl, alkylaryl, and/or alkenyl group as well as at least one anionic group selected from carboxylate, sulfate, sulfonate, phosphate, polyoxyethylene sulfate, polyoxyethylene sulfonate, polyoxyethylene phosphate, and/or salts of such anionic groups such as alkali metal salts (e.g., sodium, potassium) and ammonium salts. Any fatty acid soap (e.g., alkyl succinates), ethoxylated fatty acids, and/or the alkali metal salts ammonium salts thereof, dialkylsulfosuccinates, and sulfated oils may be useful. Some useful anionic surfactants include sodium lauryl sulfate, sodium lauryl ether sulfate, sodium dodecylbenzene sulfonate and sulfosuccinate esters. Representative commercial examples of anionic surfactants include sodium lauryl sulfate, available from Stepan Chemical Co. under the trade designation “POLYSTEP B-3”; sodium lauryl ether sulfate, available from Stepan Chemical Co. under the trade designation “POLYSTEP B-12”; and sodium dodecylbenzenesulfonate, available from Rhodia, Incorporated under the trade designation “RHODACAL DS-10”. Combinations of any of these surfactants may be useful.

In some embodiments, the emulsifier is copolymerizable with the monomer or monomer mixture and becomes incorporated into the acrylic polymer. The copolymerizable emulsifier has at least one group, or only one group, capable of reacting with the monomer or monomer mixture. Such reactive groups include ethylenically unsaturated groups such as vinyl groups and acrylate groups. Examples of polymerizable emulsifiers include sodium styrene sulfonate (commercially available from Alfa Aesar), sodium vinylsulfonate, polysodium styrene sulfonate, polyoxyethylene alkylphenyl ether ammonium sulfates those obtained under the trade designation “HITENOL BC” from Montello, Inc., Kyoto, Japan, including polyoxyethylene nonylpropenyl phenyl ether ammonium sulfate, polyoxyethylene styrenated phenyl ether ammonium sulfates such as those obtained under the trade designation “HITENOL AR” from Montello, Inc., and polyoxyethylene alkylether sulfuric esters such as those obtained under the trade designation “HITENOL KH” from Montello, Inc.

The total amount of surfactant used in the preparation of the emulsion is typically 5 parts or less, 3 parts or less, 2 parts or less, 1.75 parts or less, 1.5 parts or less, or 1.3 parts of less by weight per 100 parts by weight of the total monomers. In some embodiments, the total amount of emulsifier employed is anionic in nature.

In some embodiments a small amount (e.g., less than 5 wt. % of the total surfactant amount) of nonionic surfactant may be employed if desired. Such surfactants are well known to those skilled in the art. Representative commercial examples of nonionic surfactants include the “TRITON X” series of surfactants (octylphenol ethoxylates), “TRITON CG 600” (a polyalkyl glucoside) available from Dow Chemical Company, and polymerizable surfactants including polyoxyethylene alkylphenyl ethers such as those obtained under the trade designation “NOIGEN RN” from Montello, Inc.

Emulsion polymerization is carried out in water. The water is present in the spray adhesive composition or composition of the present disclosure. The amount of water in the spray adhesive composition or composition is typically at least 25% by weight or 30% by weight, based on the total weight of the composition. The amount of water in the spray adhesive composition or composition can be up to 55%, 50%, 45%, or 40% by weight, based on the total weight of the composition. Useful amount of water in the compositions can be in a range from 25% to 55% by weight, 25% to 50% by weight, or 30% to 40% by weight, based on the total weight of the composition.

Polymerizing the at least one alkyl acrylate or alkyl methacrylate to form acrylic polymer typically involves a polymerization initiator. Polymerization initiators useful in preparing the acrylate polymers used in the present disclosure include initiators that, on exposure to heat, generate free-radicals, which initiate polymerization of the monomer or monomer mixture. Water-soluble initiators are useful for preparing the acrylate polymers by emulsion polymerization. Suitable water-soluble initiators include potassium persulfate, ammonium persulfate, sodium persulfate, and mixtures thereof, oxidation-reduction initiators such as the reaction product of the above-mentioned persulfates and reducing agents such as those selected from the group metabisulfites, formaldehyde sulfoxylate, 4,4′-azobis(4-cyanopentanoic acid) and its soluble salts (e.g., sodium, potassium), and advanced sulfinic acid derivatives such as those obtained under the trade designations “BRUGGOLITE FF6 M” and “BRUGGOLITE TP1651” from L. Brüeggemann GMBH & Co. KG., Heilbronn, Germany. When used, initiators may comprise from about 0.01 to about 1 part by weight, 0.05 to about 1 part by weight, or about 0.1 to about 0.5 part by weight based on 100 parts by weight of monomer or monomer. A final oxidation/reducing initiator pair can be added at the end of the reaction to increase conversion. While oil-soluble may be useful in some embodiments of polymerizing the at least one alkyl acrylate or alkyl methacrylate and/or some embodiments of the process of making a composition according to the present disclosure, oil-soluble initiators may lead to more stable emulsions in some cases, which may prevent the emulsion from coagulating upon exposure to shear forces (e.g., spraying from a spray nozzle.) In some embodiments, of polymerizing the at least one alkyl acrylate or alkyl methacrylate and/or some embodiments of the process of making a composition according to the present disclosure, the polymerization initiator is a water-soluble initiator (e.g., a water-soluble free-radical initiator) or a water-soluble initiator combination including an oxidizing agent and reducing agent.

Catalysts may be useful to accelerate free radical generation. Examples of suitable catalysts include ferrous sulfate and ethylene diamine tetra-acetic acid (EDTA).

Mixtures including the acrylic monomer or combination of monomers as described above in any of their embodiments, water, and an emulsifier may optionally further comprise chain transfer agents to control the molecular weight of the acrylic polymer. Examples of useful chain transfer agents include carbon tetrabromide, alcohols, mercaptans such as, for example, isooctyl thioglycolate, and mixtures thereof.

Emulsion polymerization can be carried out at a wide variety of temperatures. The temperature can be selected readily by a person skilled in the art and can depend at least in part on the initiator used. In some embodiments, the polymerization is carried out at a temperature in a range from 10° C. to 100° C., in a range from 30° C. to 90° C., or in a range from 40° C. to 80° C.

In addition to the acrylic monomer or combination of monomers as described above in any of their embodiments, water, emulsifier, initiator, and optionally the catalyst and chain transfer agent, the following additives may also optionally be included in the emulsion compositions useful for practicing the present disclosure: inhibitors such as hydroquinone, pigments, dyes, rheology modifiers, thickeners, tackifiers, plasticizers, antioxidants (e.g., hindered phenols, amines, and sulfur and phosphorous hydroperoxide decomposers), stabilizers (e.g., ultraviolet absorbers, hindered amine light stabilizers, and heat stabilizers), fillers (e.g., inorganic fillers such as talc, zinc oxide, titanium dioxide, aluminum oxide), preservatives, biocides, corrosion inhibitors, fire retardants, and defoamers. These additives, if used, are present in conventional concentrations well known to those skilled in the art and to the extent they do not unacceptably affect the advantages provided by the present disclosure.

In some embodiments of the process for making the composition of the present disclosure, the process comprises, combining the tackifier and the at least one alkyl acrylate or alkyl methacrylate to form a solution, combining the solution with the water and the emulsifier, and polymerizing the at least one alkyl acrylate or alkyl methacrylate to form an emulsion with droplets that include both the acrylic polymer and the tackifier. The solution can include any of the other optional monomers described above. Polymerizing the monomer or monomer mixture in the presence of the tackifier can lead to good mixing of the tackifier and acrylic polymer, which can help improve adhesive performance.

Acrylic polymers including monomer units of at least one alkyl acrylate or alkyl methacrylate, in which alkyl has at least 8, 10, 11, or 12 carbon atoms, in some embodiments, at least 10, 11, or 12 carbons, tend to be more compatible with tackifiers, in some embodiment, hydrocarbon tackifiers. Incompatibility of the acrylic polymer and tackifier, if present, can lead to coagulation during emulsion polymerization of the acrylic polymer. Such an emulsion would not be stable under storage or use conditions and would not provide good adhesive performance.

The emulsion as described above in any of its embodiments, including embodiments in which comprises droplets including both the acrylic polymer and the tackifier, includes droplets having a size in a range from 50 nanometers (nm) to 10 micrometers, from 50 nanometers to 5 micrometers, or from 200 nanometers to 500 nanometers as determined by dynamic light scattering measurements, which is a technique well-known to a person skilled in the art of emulsion polymerization. In some embodiments, the droplet size is 500 nm or less, 400 nm or less, or 300 nm or less. In some embodiments, the droplet size is at least 50 nm, at least 100 nm, or at least 130 nm.

Upon completion of the emulsion polymerization, the emulsion useful in the compositions and methods of the present disclosure is typically acidic as determined using a standard pH meter or pH paper as is known to those skilled in the art. In some embodiments, the pH of the emulsion is about 3. In some embodiments of the spray adhesive composition or composition of the present disclosure, the composition further comprises base, for example, to raise the pH. In some embodiments, the pH is raised to at least 3.5, 4, 5, 6, 7, 8, or 9. Examples of suitable bases include ammonia (e.g., aqueous ammonia or ammonium hydroxide), ethanolamine, sodium hydroxide, triethylamine, and sodium carbonate. In general, with an increase in pH, the emulsions are more stable and less likely to coagulate upon exposure to shear. However, the pH at which the emulsions are stable depends on the presence of polar monomers and the type of spray container, system, and pressure used as described in further detail below. In some embodiments, the pH is of the emulsion is in a range from 3 to 5, 3 to 6, 3 to 7, 7 to 10, 7.5 to 10, or 7 to 9.5.

In some embodiments, the emulsion useful for the spray adhesive composition, composition, or methods of the present disclosure exhibit a viscosity of 12,000 centipoise (12,000 mPa-s) or less as determined using a Brookfield Viscometer, spindle 6, at 20 rpm. In some embodiments, the viscosity of the emulsion is not more than 10,000 centipoise (10,000 mPa-s), 7500 centipoise (75000 mPa-s), 5000 centipoise (5000 mPa-s), 3000 centipoise (3000 mPa-s), or 1000 centipoise (1000 mPa-s). In some embodiments, the emulsions have a viscosity of at least 300 centipoise (300 m Pa-s) or at least 500 centipoise (500 m Pa-s).

In some embodiments, the composition or spray adhesive composition of the present disclosure and/or made by the method disclosed herein is substantially free of organic solvents. Common organic solvents include any of those have a boiling point of up to 150° C. at atmospheric pressure. The term “substantially free” means that composition or spray adhesive composition can include up to 0.5, 0.1, 0.05, or 0.01 percent by weight of any of these solvents or can be free of any of these solvents. These percentages are based on the total weight of the composition or spray adhesive composition.

In some embodiments of the spray adhesive composition or composition according to the present disclosure and/or method of making or using the composition of the present disclosure, the composition is substantially free of thermoplastic microspheres containing a blowing agent. Thermoplastics for the microspheres may refer to thermoplastics obtainable by polymerizing ethylenically unsaturated monomers such as (meth)acrylates (e.g., methyl acrylate, ethyl acrylate, methyl methacrylate, isobornyl methacrylate, or ethyl methacrylate; monomers comprising nitrile groups (e.g., acrylonitrile, methacrylonitrile, alpha-chloroacrylonitrile, alpha-ethoxyacrylonitrile, fumaronitrile, or crotonitrile); vinyl halides (e.g., vinyl chloride); vinyl esters (e.g., vinyl acetate); vinylpyridine; vinylidene halides (e.g., vinylidene chloride); styrenes (e.g., styrene, halogenated styrenes, or alpha-methylstyrene); dienes (e.g., butadiene, isoprene, or chloroprene); and vinyl ethers (e.g., alkyl vinyl ethers having from one to ten carbon atoms). Blowing agents for the microspheres may refer to a liquid having a boiling point not higher than the softening temperature of the thermoplastic polymer shell, and may comprise hydrocarbons (e.g., propane, n-pentane, isopentane, neopentane, butane, isobutane, hexane, isohexane, neohexane, heptane, isoheptane, octane, isooctane, and mixtures thereof, and petroleum ethers) and chlorinated or fluorinated hydrocarbons (e.g., methyl chloride, methylene chloride, dichloroethane, dichloroethylene, trichloroethane, trichloroethylene, trichlorofluoromethane, and perfluorinated hydrocarbons. In some embodiments, the composition is substantially free of thermoplastic microspheres obtained from Akzo Nobel under the trade designation “EXPANCEL”. “Substantially free” of thermoplastic microspheres containing a blowing agent refers to less than 0.1, or up to 0.099, 0.075, 0.05, 0.01, or 0.005 percent by weight, based on the total weight of the aqueous dispersion. The microspheres expand when the temperature is raised and are said to coagulate aqueous polymer dispersions in U.S. Pat. No. 9,624,408 (Pietsch et al.) and 10,662,263 (Schmidt et al.). Advantageously, the compositions or spray adhesive compositions of the present disclosure do not require the addition of thermoplastic microspheres containing a blowing agent (with the concomitant increase in cost) or the application of heat to coagulate at a desired time.

The spray adhesive composition or composition according to the present disclosure and/or made by the process of the present disclosure typically and advantageously does not require an external coagulant, such as citric acid, lactic acid, acetic acid, or zinc sulfate. Thus, the method of making a bonded article comprising a first substrate and a second substrate does not require a second part including such a coagulant in a predetermined ratio with the composition or spray adhesive composition of the present disclosure. Thus, the compositions and methods of the present disclosure avoid disadvantages associated with a two-part system, for example, the co-spraying equipment being expensive and requiring maintenance and the complexity of monitoring the ratio of the two parts (i.e., the coagulant and the adhesive composition). Furthermore, the spray adhesive composition or composition according to the present disclosure and/or made by the process of the present disclosure does not require a chemical reaction to take place upon spraying or after spraying for coagulation.

In some embodiments, the emulsion useful for the spray adhesive composition, composition, or methods of the present disclosure comprises not more than 0.05, 0.01, or 0.005 weight percent of or is free of a compound which is not polymerizable by radical polymerization and which comprises at least 2 functional groups capable of reacting with at least one of a hydroxyl, epoxy, ketone, aldehyde, or acetoacetate group, the weight percentages being based on the total amount of monomer units in the acrylic polymer.

In some embodiments, the spray adhesive composition or composition according to the present disclosure and/or made by the process of the present disclosure is packaged in a spray container. Any of a variety of different spray containers may be useful for delivering the composition of the present disclosure and may be useful in the method of making a bonded article according to the present disclosure. For example, an air-assisted spray system may be useful. Examples of useful air-assisted spray systems include those obtained under the trade designation “3M Accuspray ONE Spray Gun System with Standard PPS” and “3M Accuspray Paint Spray System with PPS 2.0” from 3M Company, St. Paul, Minnesota. Thus, the spray container may be a disposable cup or cup and disposable liner attached to a spray gun with an atomizing head or nozzle. Spray can be assisted using compressed air, for example, at pressures in a range from 0.13 Megapascals (MPa) to 0.21 MPa.

In other embodiments, an airless spray system may be used for the compositions and methods of the present disclosure. Pressure pots such as one-liter capacity pots with pressure rating up to 225 psi (1.24 MPa), obtained, for example, from Apache Stainless Steel Equipment Corporation, Beaver Dam, Wisconsin can be connected to a nylon hose obtained, for example, under the trade designation “3M Cylinder Adhesive Hose” from 3M Company, St. Paul, Minnesota. The hose can be, for example, up to 8, 7, 6, 5, 4, 3, 2, or 1 meter long. A high throughput metallic spray gun obtained, for example, under the trade designations “GunJet” and “H GunJet” from Spray Systems Co., Minnetonka, Minnesota with a brass spray nozzle obtained, for example, under the trade designations “4001 UniJet”, “6501 UniJet”, “9501 UniJet”, “1100050 UniJet”, and “800050 UniJet” from Spray Systems Co. may conveniently attached to the hose. The canister can be pressurized with dry nitrogen gas or any desirable gas.

In other embodiments, aerosol cans may be used for the compositions and methods of the present disclosure. Aerosol cans can be obtained from a variety of sources, for example, from Ball Metalpack, Broomfield, Colorado, under the trade designation “Classic Tinplate Can”. Any aerosol actuator, for example, that obtained under the trade designation “Seaquist 802-24-20/0890-20FS” from Aptar, Mukwonago, Wisconsin with Buna valves obtained under the trade designation “AR-83” from Aptar, may be useful. Aerosols typically include a propellant. Examples of suitable propellants include nitrogen, carbon dioxide, ethane, propane, isobutane, normal butane, dimethyl ether, 1,1-difluoroethane, trans-1,3,3,3-tetrafluoropropene, and mixtures thereof. Typically, liquid aerosol propellants such as propane, butane, and isobutane are added to the composition or spray adhesive composition in an amount ranging from about 5% to about 45% by weight, based on the total weight of the composition. When gases such as nitrogen and carbon dioxide are used as the propellant, the gas propellant is typically present in an amount ranging up to about 10%, 8%, 6%, 5%, or 2% by weight, based on the total weight of the composition.

Typically, and advantageously, the composition or spray adhesive composition, which is generally stable and not coagulated at rest (e.g., inside the spray container) coagulates upon being subjected to shear forces to form a pressure-sensitive adhesive.

The shear rates at which the composition or spray adhesive composition coagulates may be in a range from 100 l/second to 500,000 l/second. Shearing may take place by passage through a microchannel with a diameter in a range, for example, from 0.2 millimeter (mm) to 10 mm.

Useful measures of coagulation to form a pressure-sensitive adhesive are the Time to Hold and Instant Tack and Hold evaluation described in the Examples, below. As shown in Tables 4 and 5 in the Examples, below, Examples 1 to 14 of the present disclosure demonstrate quick bonding ability with a Time to Hold of less than one minute. Examples 10 to 14 were shown to pass the Instant Tack and Hold evaluation. In contrast, Comparative Example 1 includes about 1.6 percent by weight acrylic acid and methacrylic acid, based on the total weight of the monomer units in the acrylic polymer. As shown in Table 5, the time to hold was significantly greater for Comparative Example 1 (5 minutes) than for Examples 1 to 14, and Comparative Example 1 did not pass the Instant Tack and Hold evaluation.

Thus, we have found that emulsions of acrylic polymers having little to no carboxylic acid, sulfonic acid, and phosphonic acid groups can coagulate upon being subjected to shear forces such as those induced in a spray nozzle and quickly develop PSA properties. In addition to the amount of acid, the following factors can affect the ability of the composition to coagulate upon being subjected to shear: the amount of emulsifier, the presence of other polar monomer units, the hydrophobicity or hydrophilicity of the tackifier, if present, additives in the emulsion (e.g., salt), if present, pH of the emulsion, and the type of spray system. At least some of these factors can offset each other. For example, an increase in pH, the amount of emulsifier, and the amount of polar monomer units can increase the stability of the emulsion. However, pH can be lowered when higher amounts of polar monomers are present to achieve coagulation upon spraying. Different spray systems require different levels of stability so that the emulsion can be pumped and does not clog the spray nozzle before or during spraying.

For an air-assisted spray system, a pH in a range from 3 to 5 resulted in a Time to Hold of less than one minute as shown in Examples 1 to 10 in Tables 4 and 5. In the case of the airless spray system in pressurized canisters, the pumpability of the emulsion is more important because it must travel through a hose. To achieve good pumping and spraying through the airless system, a pH in the range from 7 to 9 was useful. When the pH was lower than 7, the hose either seized completely or pumped some amount of coagulated adhesive and thus rapidly clogged the nozzle. Increasing the amount of emulsifier (even by one or two percent, based on the weight of emulsifier) can also help in the airless system. Tuning the pH range of coagulating spray can be useful depending on the monomer composition of the emulsion. We have found that when polar monomers are present in the acrylic polymer, a lower pH can be useful for achieving a Time to Hold of less than one minute. Examples 12 to 14 in Table 3, below, have the same composition except for the amount of polar monomer, diacetone acrylamide. As shown in Table 5, Example 12, without any acid-containing monomers or polar monomers, a pH range from 7.5 to 9.5 may be useful as shown. Then with addition of a small quantity (0.1 wt. %) of diacetone acrylamide (Example 14), a range of about pH 6.5 to 7.5 may be useful. Finally, with a doubling of the amount of diacetone acrylamide to about 0.2 wt. % as shown in Example 13, a pH range of pH 3 to 5.5 may be useful.

Coagulation upon being subjected to shear also can advantageously prevent the composition or spray adhesive composition of the present disclosure from soaking into a nonporous substrate. This feature can improve bond strength and decrease the amount of adhesive necessary to make an adhesive bond. In the Instant Tack and Hold evaluation described in the Examples below, the substrate is a polypropylene nonwoven fabric commonly used for geotextile application. As shown in Table 5, Examples 10 to 14 including a spray adhesive composition of the present disclosure were shown to pass the Instant Tack and Hold evaluation. As comparative examples, solvent-based adhesive “3M HOLDFAST 70” Spray Adhesive and water-based “3M FASTBOND Foam Adhesive 100NF” and “3M FAST TACK Water-Based Adhesive 1000NF” did not pass the Instant Tack and Hold evaluation. Water-based “3M FASTBOND Foam Adhesive 100NF” is reported to produce a “pebble spray” and does not coagulate upon spraying.

Examples 7 to 14 demonstrate that increasing the amount of high T_{g} monomer units, crosslinking monomer units, and/or tackifier softening point can increase the peel and shear strength of the adhesive composition of the present disclosure and/or allow it to be used at higher temperatures, which can be beneficial for some applications.

The present disclosure provides an article that comprises a first substrate and a second substrate bonded together with a composition of the present disclosure and a method of making such an article. The surfaces of the first substrate and the second substrate may be any desired material. In some embodiments, at least one of the surfaces of the first substrate or the surface of the second substrate comprises at least one of metal, glass, a polymer, paper, a painted surface, a nonwoven or woven fabric, or a composite. The material of the surface of the first and second substrate may be found throughout the substrate, or the surface may include a different material from the bulk of the substrate. In some embodiments, the surface of the first substrate and/or second substrate comprises at least one of metal (e.g., steel, stainless steel, or aluminum), glass (e.g., which may be coated with indium tin oxide, for example,), a polymer (e.g., a plastic, rubber, thermoplastic elastomer, or thermoset), paper, a painted surface, or a composite. A composite material may be made from any two or more constituent materials with different physical or chemical properties. When the constituents are combined to make a composite, a material having characteristics different from the individual components is typically achieved. Some examples of useful composites include fiber-reinforced polymers (e.g., carbon fiber reinforced epoxies and glass-reinforced plastic); metal matrix compositions, and ceramic matrix composites. The surface of at least one of the first or second substrates may include polymers such as polyolefins (e.g., polypropylene, polyethylene, high density polyethylene, blends of polypropylene), polyamide 6 (PA6), acrylonitrile butadiene styrene (ABS), polycarbonate (PC), PC/ABS blends, polyvinyl chloride (PVC), polyamide (PA), polyurethane (PUR), thermoplastic elastomers (TPE), polyoxymethylene (POM), polystyrene, polyester (e.g., polyethylene terephthalate), poly(methyl) methacrylate (PMMA), and combinations thereof. The surface of at least one of the first or second substrate may also include a metal coating on such polymers. In some embodiments, at least one of the first or second substrate comprises a transparent material such as glass or a polymer (e.g., acrylic or polycarbonate).

In some embodiments, at least one of the first substrate or second substrate is a woven or nonwoven fabric. The term “nonwoven” refers to a material having a structure of individual fibers or threads that are interlaid but not in an identifiable manner such as in a knitted fabric. Examples of nonwoven webs include spunbond webs, spunlaced webs, needle-punched webs, airlaid webs, meltblown web, and bonded carded webs. Useful nonwovens may be made of natural fibers (e.g., wood or cotton fibers), synthetic fibers (e.g., thermoplastic fibers), or a combination of natural and synthetic fibers. Examples of suitable materials for forming thermoplastic fibers include polyolefins (e.g., polyethylene, polypropylene, polybutylene, ethylene copolymers, propylene copolymers, butylene copolymers, and copolymers and blends of these polymers), polyesters, and polyamides. The fibers may also be multi-component fibers, for example, having a core of one thermoplastic material and a sheath of another thermoplastic material. Examples of woven fabrics include twill and canvas.

In some embodiments, at least one of the first substrate or the second substrate is a low surface energy substrate. The term “low surface energy substrate” is meant to refer to those substrates having a surface energy of less than 34 dynes per centimeter. Included among such materials are polypropylene, polyethylene [e.g., high density polyethylene (HDPE), low density polyethylene (LDPE), and liner low density polyethylene (LLDPE)], and blends of polypropylene (e.g., PP/EPDM, TPO). In some embodiments, at least one of the first substrate or the second substrate is a medium surface energy substrate. The term “medium surface energy substrates” is meant to refer to those substrates having a surface energy in a range from 34 to 70 dynes per centimeter, typically from 34 to 60 dynes per centimeter, and more typically from 34 to 50 dynes per centimeter. Included among such materials are polyamide 6 (PA6), acrylonitrile butadiene styrene (ABS), polycarbonate (PC)/ABS blends, PC, PVC, polyamide (PA), polyurethane (PUR), thermoplastic elastomers (TPE), polyoxymethylene (POM), polystyrene, and poly(methyl methacrylate) (PMMA). The surface energy is typically determined from contact angle measurements as described for example in ASTM D7490-08.

The composition or spray adhesive composition of the present disclosure can be useful in a variety of applications. For example, the composition can be useful for bonding geotextiles. Geotextiles are typically made from nonwoven or woven fabric and may be made from low surface energy materials such as polyolefins. Examples of materials useful as geotextiles include polypropylene and polyethylene terephthalate (PET). The composition can also be useful for graphics attachment (e.g., branding or information graphics) and plastic assembly. Examples of useful substrate surfaces for graphics attachment include polypropylene, ABS, PC, aluminum, steel, and painted surfaces. Graphic films can be made, for example, from PUR or PVC. The composition of the present disclosure can also be useful for bonding dissimilar materials together. In some of these embodiments, the first substrate comprises a metal, and the second substrate comprises a rubber or plastic. In some embodiments, the first and second substrates are dissimilar plastics. The composition of the present disclosure can also be useful for foam lamination in which either the first or second substrate is a foam (e.g., a polymer foam such as polyurethane, EPDM, and polyethylene foam). The composition of the present disclosure can also be useful for packaging in which either the first or second substrate is a paper (e.g., polymer-coated paper) or paperboard.

### Some Embodiments of the Disclosure

In a first embodiment, the present disclosure provides a spray adhesive composition comprising: an acrylic polymer comprising monomer units of at least one alkyl acrylate or alkyl methacrylate, wherein alkyl has at least 8 carbon atoms, and not more than one percent by weight of monomer units include a carboxylic acid, sulfonic acid, or phosphonic acid, based on the total weight of monomer units in the acrylic polymer;
an emulsifier; and
water,
   wherein the spray adhesive composition is an emulsion of the acrylic polymer in water.

In a second embodiment, a composition comprising:
an acrylic polymer comprising monomer units of at least one alkyl acrylate or alkyl methacrylate, wherein alkyl has at least 8 carbon atoms, and not more than one percent by weight of monomer units include a carboxylic acid, sulfonic acid, or phosphonic acid, based on the total weight of monomer units in the acrylic polymer;
an emulsifier; and
water,
   wherein the composition is an emulsion of the acrylic polymer in water, and wherein the composition coagulates upon being subjected to shear forces to form a pressure-sensitive adhesive.

In a third embodiment, the present disclosure provides the composition or spray adhesive composition of the first or second embodiment, wherein alkyl has at least 10, 11, or 12 carbon atoms. In a fourth embodiment, the present disclosure provides the composition or spray adhesive composition of any one of the first to third embodiments, further comprising a tackifier, for example, a hydrocarbon tackifier.

In a fifth embodiment, the present disclosure provides the composition or spray adhesive composition of the fourth embodiment, wherein the emulsion comprises droplets comprising both the tackifier and the acrylic polymer.

In a sixth embodiment, the present disclosure provides the composition or spray adhesive composition of the third or fourth embodiment, wherein the tackifier is present in the composition in a range from two parts to 30 parts per one hundred parts of acrylic polymer.

In a seventh embodiment, the present disclosure provides the composition or spray adhesive composition of any one of the first to sixth embodiments, wherein the acrylic polymer further comprises monomer units of a second monomer comprising at least one of a C₄-C₉ alkyl acrylate or C₄-C₉ alkyl methacrylate.

In an eighth embodiment, the present disclosure provides the composition or spray adhesive composition of any one of the first to seventh embodiments, wherein the acrylic polymer further comprises monomer units of a high T_{g} monomer that when polymerized provides a homopolymer having a glass transition temperature of at least 40° C.

In a ninth embodiment, the present disclosure provides the composition or spray adhesive composition of any one of the first to eighth embodiments, wherein the acrylic polymer further comprises monomer units of a polar monomer including at least one ketone, amide, amine, alcohol, or a combination thereof.

In a tenth embodiment, the present disclosure provides the composition or spray adhesive composition of any one of the first to ninth embodiments, wherein alkyl has 8 to 20, 10 to 20, 12 to 20, or 12 to 16 carbon atoms.

In an eleventh embodiment, the present disclosure provides the composition or spray adhesive composition of any one of the first to tenth embodiments, wherein the acrylic polymer further comprises monomer units of an acrylate or methacrylate having more than one acrylate or methacrylate group.

In a twelfth embodiment, the present disclosure provides the composition or spray adhesive composition of any one of the first to eleventh embodiments, wherein the acrylic polymer is free of monomer units comprising a carboxylic acid, sulfonic acid, or phosphonic acid.

In a thirteenth embodiment, the present disclosure provides the composition or spray adhesive composition of any one of the first to twelfth embodiments, further comprising a base.

In a fourteenth embodiment, the present disclosure provides the composition or spray adhesive composition of any one of the first to thirteenth embodiments, further comprising a propellent.

In a fifteenth embodiment, the present disclosure provides the composition or spray adhesive composition of any one of the first to fourteenth embodiments, wherein the composition or the spray adhesive composition is substantially free of thermoplastic microspheres containing a blowing agent.

In a sixteenth embodiment, the present disclosure provides the composition or spray adhesive composition of any one of the first to fifteenth embodiments, packaged in a spray container.

In a seventeenth embodiment, the present disclosure provides the composition or spray adhesive composition of any one of the first to sixteenth embodiments, wherein the emulsion coagulates upon being sprayed.

In an eighteenth embodiment, the present disclosure provides the composition or spray adhesive composition of any one of the first to seventeenth embodiments, wherein the emulsion comprises droplets having a size in a range from 50 nanometers to 10 micrometers, from 50 nanometers to 5 micrometers, or from 200 nanometers to 500 nanometers.

In a nineteenth embodiment, the present disclosure provides the composition or spray adhesive composition of any one of the first to eighteenth embodiments, wherein the acrylic polymer is a nonionic polymer.

In a twentieth embodiment, the present disclosure provides the composition or spray adhesive composition of any one of the first to nineteenth embodiments, wherein the acrylic polymer is not a core-shell polymer.

In a twenty-first embodiment, the present disclosure provides the composition or spray adhesive composition of any one of the first to twentieth embodiments, wherein the acrylic polymer consists of monomer units of at least one alkyl acrylate or alkyl methacrylate, wherein alkyl has at least 8 carbon atoms and optionally monomer units of a second monomer comprising at least one of a C₄-C₉ alkyl acrylate or C₄-C₉ alkyl methacrylate.

In a twenty-second embodiment, the present disclosure provides the composition or spray adhesive composition of any one of the first to twentieth embodiments, wherein the acrylic polymer consists essentially of monomer units of at least one alkyl acrylate or alkyl methacrylate, wherein alkyl has at least 8 carbon atoms and optionally monomer units of a second monomer comprising at least one of a C₄-C₉ alkyl acrylate or C₄-C₉ alkyl methacrylate. In this context, “consists essentially of” refers to not including any monomer units that prevent the composition from coagulating upon exposure to shear forces.

In a twenty-third embodiment, the present disclosure provides the composition or spray adhesive composition of any one of the first to twentieth embodiments, comprising not more than 0.05, 0.01, or 0.005 weight percent of or which is free of a compound which is not polymerizable by radical polymerization and which comprises at least 2 functional groups capable of reacting with at least one of a hydroxyl, epoxy, ketone, aldehyde, or acetoacetate group, the weight percentages being based on the total amount of monomer units in the acrylic polymer.

In a twenty-fourth embodiment, the present disclosure provides a process for making the composition of any one of the first to twenty-third embodiments, the process comprises:
combining the at least one alkyl acrylate or alkyl methacrylate with the water and the emulsifier; and
polymerizing the at least one alkyl acrylate or alkyl methacrylate to form an emulsion.

In a twenty-fifth embodiment, the present disclosure provides a process for making the composition of any one of the fourth to sixth embodiments, the process comprises:
combining the tackifier and the at least one alkyl acrylate or alkyl methacrylate to form a solution;
combining the solution with the water and the emulsifier; and polymerizing the at least one alkyl acrylate or alkyl methacrylate to form an emulsion with droplets that include both the acrylic polymer and the tackifier.

In a twenty-sixth embodiment, the present disclosure provides the process of the twenty-fifth embodiment, wherein a second monomer comprising at least one of a C₄-C₉ alkyl acrylate or C₄-C₉ alkyl methacrylate is combined with the tackifier and the at least one alkyl acrylate or alkyl methacrylate.

In a twenty-seventh embodiment, the present disclosure provides the process of the twenty-fifth or twenty-sixth embodiment, wherein a high T_{g} monomer that when polymerized provides a homopolymer having a glass transition temperature of at least 40° C. is combined with the tackifier and the at least one alkyl acrylate or alkyl methacrylate.

In a twenty-eighth embodiment, the present disclosure provides the process of any one of the twenty-fifth to twenty-seventh embodiments, wherein a polar monomer including at least one ketone, amide, amine, alcohol, or a combination thereof is combined with the tackifier and the at least one alkyl acrylate or alkyl methacrylate.

In a twenty-ninth embodiment, the present disclosure provides the process of any one of the twenty-fifth to twenty-eighth embodiments, wherein alkyl has 8 to 20, 10 to 20, 12 to 20, or 12 to 16 carbon atoms.

In a thirtieth embodiment, the present disclosure provides the process of any one of the twenty-fifth to twenty-ninth embodiments, wherein an acrylate or methacrylate having more than one acrylate or methacrylate group is combined with the tackifier and the at least one alkyl acrylate or alkyl methacrylate.

In a thirty-first embodiment, the present disclosure provides the process of any one of the twenty-fifth to thirtieth embodiments, wherein the solution is free of monomers comprising a carboxylic acid, sulfonic acid, or phosphonic acid.

In a thirty-second embodiment, the present disclosure provides the process of any one of the twenty-fifth to thirty-first embodiments, wherein the droplets have a size in a range from 50 nanometers to 10 micrometers, from 50 nanometers to 5 micrometers, or from 200 nanometers to 500 nanometers.

In a thirty-third embodiment, the present disclosure provides the process of any one of the twenty-fifth to thirty-second embodiments, wherein the acrylic polymer is a nonionic polymer.

In a thirty-fourth embodiment, the present disclosure provides a method of making a bonded article comprising a first substrate and a second substrate, the method comprising:
spraying the composition of any one of the first to twenty-third embodiments on at least one of the first substrate or the second substrate; and
adhering the first substrate and the second substrate together.

In a thirty-fifth embodiment, the present disclosure provides the method of the thirty-fourth embodiment, wherein the emulsion coagulates upon spraying to form an adhesive.

In a thirty-sixth embodiment, the present disclosure provides the method of the thirty-fourth or thirty-fifth embodiment, wherein the adhesive is tacky within one minute after spraying.

In a thirty-seventh embodiment, the present disclosure provides the method of any one of the thirty-fourth to thirty-sixth embodiments, wherein at least one of the first substrate or the second substrate is a nonwoven or woven fabric.

In a thirty-eighth embodiment, the present disclosure provides the method of any one of the thirty-fourth to thirty-seventh embodiment, at least one of the first substrate or the second substrate is a low surface energy substrate.

In order that this disclosure can be more fully understood, the following examples are set forth. It should be understood that these examples are for illustrative purposes only and are not to be construed as limiting this disclosure in any manner.

### EXAMPLES

Unless otherwise noted, all parts, percentages, ratios, etc. in the Examples and the rest of the specification are by weight. The following abbreviations are used in this section: min=minutes, s=second, h=hour, g=gram, mg=milligrams, mL=milliliters, m=meter, centimeter=cm, mm=millimeter, ° C.=degrees Celsius, ° F.=degrees Fahrenheit, MPa=megapascals, N=Newtons, oz=ounce, sqft=square foot, psi=pounds per square inch, and kPa=kilopascals.

Table 1 (below) lists materials used in the examples and their sources.

TABLE 1
Materials List

| DESIGNATION | DESCRIPTION |
|---|---|
| EHA | Ethylhexyl acrylate, obtained from BASF, Florham |
| | Park, New Jersey |
| OAIB | Octyl acrylate isomer blend prepared as described |
| | in U.S. Pat. No. 9,102,774 (Clapper et al.) |
| DAIB | Dodecyl acrylate isomer blend prepared as described |
| | in U.S. Pat. No. 9,102,774 (Clapper et al.) |
| AA | Acrylic acid, obtained from Alfa Aesar, Ward Hill, |
| | Massachusetts |
| MAA | Methacrylic acid, obtained from Alfa Aesar, Ward |
| | Hill, Massachusetts |
| IBOA | Isobornyl acrylate, obtained from Sans Ester, New |
| | York, New York |
| DAAM | Diacetone acrylamide, obtained from Alfa Aesar, |
| | Ward Hill, Massachusetts |
| AAEM | Acetoacetoxy ethyl methacrylate, obtained from TCI |
| | America, Portland, Oregon |
| HDDA | 1,6-Hexanediol diacrylate, obtained from Alfa Aesar, |
| | Ward Hill, Massachusetts |
| ARKON | Fully hydrogenated hydrocarbon tackifier, obtained |
| P100 | under the trade name “ARKON P100”, from |
| | Arakawa, Osaka, Japan |
| ARKON | Fully hydrogenated hydrocarbon tackifier, obtained |
| P125 | under the trade name “ARKON P125”, from |
| | Arakawa, Osaka, Japan |
| ARKON | Fully hydrogenated hydrocarbon tackifier, obtained |
| P140 | under the trade name “ARKON P140”, from |
| | Arakawa, Osaka, Japan |
| ARKON | Partially hydrogenated hydrocarbon tackifier, |
| M100 | obtained under the trade name “ARKON M100”, |
| | from Arakawa, Osaka, Japan |
| ARKON | Partially hydrogenated hydrocarbon tackifier, |
| M135 | obtained under the trade name “ARKON M135”, |
| | from Arakawa, Osaka, Japan |
| KPS | Potassium persulfate 1, obtained from Sigma Aldrich, |
| | St. Louis, Missouri |
| HITENOL | Polyethylene nonylpropenyl phenyl ether ammonium |
| BC-1025 | sulfate surfactant, 25% by weight in water, obtained |
| | under the trade name “HITENOL BC-1025”, from |
| | Montello Inc., Kyoto Japan |
| A-108 | Propane, obtained under the trade designation |
| | “A-108”, from Diversified CPC, Channahon, |
| | Illinois |
| A-31 | Isobutane, obtained under the trade designation |
| | “A-31”, from Diversified CPC, Channahon, |
| | Illinois |
| DME | Dimethyl ether, obtained from Diversified CPC, |
| | Channahon, Illinois |
| R-152A | Difluoroethane, obtained under the trade designation |
| | “R-152A”, from Diversified CPC, Channahon, |
| | Illinois |
| FASTBOND | Contact Adhesive, obtained under the trade designation |
| 100 | “FASTBOND 100”, from 3M Company, Springfield, |
| | Missouri |
| FAST TACK | Acrylic Adhesive, obtained under the trade designation |
| 1000NF | “FAST TACK 1000NF”, from 3M Company, |
| | Springfield Missouri |
| HOLDFAST | Cylinder Adhesive, obtained under the trade |
| 70 | designation “HOLDFAST 70”, from 3M Company, |
| | Springfield, Missouri |

### Test Methods

### pH Measurement

pH was measured using pH two sets of pH paper strips (BAKER-pHIX pH 7.0-14, from J. T. Baker, Phillipsburg, New Jersey; “Cat. No. 8884-1” pH Test Strip 2-9, from Ricca Chemical Company, Arlington, Texas) and taking an average of the results.

### Time to Hold

Experiments on tack time of the adhesives was determined by spraying onto 1-inch-wide birch panels (2.54 cm×10.16 cm×0.32 cm panels, obtained from Forest Product Supply, St. Paul, Minnesota). then determining the time required before a 100 g weight can be held without bond failure. A 100 g weight was attached to a binder clip and clamped to another birch panel. After spraying 20-33 g/m² of adhesive onto the initial birch substrate panel, the second birch panel with the weight attached was bonded to the first one with hand pressure. They were then hung vertically to determine if the 100 g weight could be held and the time it took before the weight could be held was recorded.

### Preparation of Samples for Overlap Shear and Peel Testing and Shear Adhesion Failure Test

Desired substrates were chosen and cut into 1-inch-wide strips. The adhesive was either applied with the Air-Assisted Spray or Airless Spray systems (see description below) at wet coat weights of roughly 8-12 g/sqft. Once the adhesive was sprayed onto the substrate, the bonds were joined within 30-120 s, either rolled with a hand roller or a binder clip, allowed to dwell for 16-24 h, and then tested on a tensile tester (obtained under the trade designation “QTEST_5”, from MTS Systems Corporation, Eden Prairie, Minnesota). All numbers listed in the tables below are averages of 3-5 tests.

### Overlap Shear (OLS) and Peel Testing

Overlap shear strength was tested on a tensile tester (“QTEST_5”, from MTS Systems Corporation, Eden Prairie, Minnesota) with sample pulled at a rate of 5.08 cm/min. Strength at break was recorded for birch/birch and birch/polypropylene overlap shears. Peel strength was determined on a tensile tester (“QTEST_5”, from MTS Systems Corporation, Eden Prairie, Minnesota) with overlap shear samples pulled at 25.4 cm/min. Data was collected as an average of 3 to 5 samples. Overlap shear strengths were reported in megapascals (MPa) and peel strength was recorded in Newtons per 25 mm (N/25 mm).

### Shear Adhesion Failure Test (SAFT)

SAFT was performed by placing the 2.54 cm² area bonded birch OLS samples (2.54 cm×10.16 cm×0.32 cm panels, obtained from Forest Product Supply, St. Paul, Minnesota) into an oven (“MODEL RFD2-13-2E”, from Despatch ITW-EAE, Lakeville, Minnesota) and hanging a 100 g weight from the bottom of the birch wood panel. The temperature of the oven was started at 90° F. (32° C.) and increased by 10° F. every ten minutes until bond failure. The temperature at which the bond broke was recorded. Data was collected and recorded as an average of 3 to 5 samples.

### Instant Tack-and-Hold Test

Non-woven polypropylene geotextile fabric samples (Mirafi 140N”, “Mirafi 180N”, and/or “Mirafi S1600” from TenCate Geosynthetics, Mt. Pleasant, South Carolina. Densities are as follows: 140N is 4 oz/sqft, 180N is 8 oz/sqft, and S1600 is 16 oz/sqft.), canvas (“#10 cotton duck”, from Canwil Textiles, Auburn, Georgia) samples, and/or woven polyethylene terephthalate fabric samples (“Mirafi PET300”, from TenCate Geosynthetics, Mt. Pleasant, South Carolina) were cut into 15.24 cm by 7.62 cm pieces. A substrate sample was taped over with masking tape to expose only 5.08 cm by 7.62 cm sections. The samples were then sprayed with adhesives (30-40 g/m²) using either air assist or airless spray systems (detailed below). The samples were then immediately joined to an area of 5.08 cm by 7.62 cm and rolled with a hand roller using hand pressure. Data was collected and recorded as an average of 3 samples. Pass was considered a fabric overlap shear strength of >10 psi (>68 kPa) at <1 min after spraying and bonding the substrates. Comparative Example 1 (Table 2) did not pass the instant tack-and-hold test as shown in Table 5.

Comparative Example 2 was “FASTBOND 100” Contact Adhesive, which also did not pass the instant tack-and-hold test when it was applied using the Air-Assisted Spray method described below.

### Air Assisted Spray

Air assisted spray performance was explored using an air assisted spray system (obtained under the trade designation “3M Accuspray ONE Spray Gun System with Standard PPS” and/or “3M Accuspray Paint Spray System with PPS 2.0” from 3M Company, Lindstrom, Minnesota). The adhesive was fed through the gun with a gravity feed cup on the back and disposable 1.8 mm plastic nozzles. Air pressures were 0.14 MPa obtained from house compressed air.

### Airless Spray

Airless spray performance was explored using pressure pots (custom 1 L capacity pots with pressure rating up to 225 psi, from Apache Stainless Steel Equipment Corporation, Beaver Dam, Wisconsin) connected to a nylon hose (obtained under the trade designation “3M Cylinder Adhesive Hose” from 3M Company, Pine City, Minnesota) with a high throughput metallic spray gun (obtained under the trade designation “H GunJet” from Spray Systems Co., Minnetonka, Minnesota) with a brass spray nozzle (obtained under the trade designation “9501 UniJet” from Spray Systems Co., Minnetonka, Minnesota). The canister was pressurized to 1.24 MPa with dry nitrogen gas.

### Examples 1-9

The organic phase of the pre-emulsion was prepared by mixing all acrylic monomers and tackifiers (EHA, OAIB, DAIB, IBOA, HDDA, DAAM, AAEM, AA, ARKON P100, ARKON P125, ARKON P140, ARKON M100, ARKON M135) together under mixing until fully dissolved. An aqueous phase of the pre-emulsion was then also prepared with 17.8 g of emulsifier (HITENOL BC-1025) and 202 g of water. Under vigorous stirring, the organic phase was added slowly to the aqueous phase to form the pre-emulsion (PE), which was then stirred for an additional 15-25 min. The PE was then blended in a commercial blender (“Blender 7012 MODEL 34BL21” from Waring, McConnellsburg, Pennsylvania) for 3 minl on setting #6 (entire quantity of pre-emulsion). Following blending, 150 g of the PE (˜25%) was added to the reactor as the initial charge. The remaining PE was added to a feeding tank. Initiator (157 mg KPS) was added to the PE in the reactor, and both the reactor and the feeding tank were purged with nitrogen gas (˜1 bubble/s with silicone oil bubbler) under stirring for 30-45 min. Next, the reactor was heated to 70° C. Once the reactor reached the desired temperature (70° C.), the PE feeding was started and took place over the course of 90-120 min using an Easy-Load Masterflex Peristaltic Pump (“MODEL 7518-00” from Cole-Parmer Instrument Company, Vernon Hills, Illinois). After 30 min of feeding, an additional charge of initiator (470 mg KPS in ˜6 mL water) was added. Once feeding was done, the polymerization was allowed to react at 70° C. for an additional 2-2.5 h, followed by cooling to room temperature and filtering through a paint filter. Table 2 below contains the monomers and tackifiers used for Examples 1-9.

TABLE 2
Formulations for Examples 1-9

| | | | | | | | | | | Compar- |
|---|---|---|---|---|---|---|---|---|---|---|
| | Example | | | | | | | | | ative |
| | 1 | 2 | 3 | 4 | 5 | 6 | 7 | 8 | 9 | Example 1 |
| | amount | amount | amount | amount | amount | amount | amount | amount | amount | amount |
| Component | (g) | (g) | (g) | (g) | (g) | (g) | (g) | (g) | (g) | (g) |
| EHA | | | | | | | 135.6 | | | |
| OAIB | 175.6 | 175.6 | 175.6 | 175.6 | 135.6 | 155.6 | | 135.6 | 155.6 | 219.7 |
| DAIB | 78.4 | 78.4 | 78.4 | 78.4 | 78.4 | 78.4 | 78.4 | 78.4 | 78.4 | 34.7 |
| IBOA | 47.0 | 47.0 | 47.0 | 47.0 | 87.1 | 67.1 | 87.1 | 87.1 | 67.1 | 47.1 |
| HDDA | | | | 0.2 | 0.2 | 0.3 | 0.2 | 0.2 | 0.3 | 0.5 |
| DAAM | | 1.0 | | | | | | | | |
| AAEM | | | 2.5 | | | | | | | |
| ARKON | 47.1 | 47.1 | 47.1 | 47.1 | 47.1 | 47.1 | | 23.6 | 47.1 | |
| P100 | | | | | | | | | | |
| ARKON | | | | | | | | | | |
| P125 | | | | | | | | | | |
| ARKON | | | | | | | 47.1 | 23.6 | | 47.0 |
| P140 | | | | | | | | | | |
| ARKON | 9.4 | 9.4 | 9.4 | 9.4 | 9.4 | 9.4 | | | 9.4 | |
| M100 | | | | | | | | | | |
| ARKON | | | | | | | 9.4 | 9.4 | | 9.4 |
| M135 | | | | | | | | | | |
| AA | | | | | | | | | 0.5 | 4.8 |
| MAA | | | | | | | | | | 4.8 |

### Examples 10-14

The organic phase of the pre-emulsion was prepared by mixing all acrylic monomers and tackifiers together (EHA, OAIB, DAIB, IBOA, HDDA, DAAM, AAEM, AA, ARKON P100, ARKON P125, ARKON P140, ARKON M100, ARKON M135) under mixing until fully dissolved. An aqueous phase of the pre-emulsion was then also prepared with 47.2 g emulsifier (HITENOL BC-1025) and 530 g of water. Under vigorous stirring, the organic phase was added slowly to the aqueous phase to form the pre-emulsion (PE), which was then stirred for an additional 15-25 min. The PE was then blended in a commercial blender (“Blender 7012 MODEL 34BL21” from Waring, McConnellsburg, Pennsylvania) for 3 min on setting #6 in batches of ˜500 g. Following blending, 150 g of the PE (˜10%) was added to the reactor as the initial charge. The remaining PE was added to a feeding tank. Initiator (157 mg KPS) was added to the PE in the reactor, and both the reactor and the feeding tank were purged with nitrogen gas (˜1 bubble/s with silicone oil bubbler) under stirring for 30-45 min. Next, the reactor was heated to 70° C. Once the reactor reached the 70° C. desired temperature, the PE feeding was started and took place over the course of 130-170 min using an Easy-Load Masterflex Peristaltic Pump (“MODEL 7518-00” from Cole-Parmer Instrument Company, Vernon Hills, Illinois). After 15 min of feeding, an initiator feed was started (1.471 g in 50 mL water) and fed over 1-1.5 h using a syringe pump (“NE-300 Just Infusion” from New Era Pump Systems Inc., Farmingdale, New York). Once both the PE and initiator feeds were completed, the polymerization was allowed to further react over 2-2.5 h, followed by cooling to room temperature and filtering through a paint filter. Table 3 below contains the monomers and tackifiers used for Examples 10-15.

TABLE 3
Formulations for Examples 10-14

| | Example | | | | |
|---|---|---|---|---|---|
| | 10 | 11 | 12 | 13 | 14 |
| | amount | amount | amount | amount | amount |
| Component | (g) | (g) | (g) | (g) | (g) |
| OAIB | 352.2 | 352.2 | 404.6 | 404.6 | 404.6 |
| DAIB | 203.6 | 203.6 | 203.8 | 203.8 | 203.8 |
| IBOA | 226.2 | 226.2 | 174.5 | 172.5 | 173.5 |
| HDDA | 0.52 | 0.52 | 0.78 | 0.52 | 0.52 |
| DAAM | | | | 2.0 | 1.0 |
| ARKON | 122.3 | 61.2 | 61.2 | 61.2 | 61.2 |
| P100 | | | | | |
| ARKON | | | 61.2 | 61.2 | 61.2 |
| P125 | | | | | |
| ARKON | | 61.2 | | | |
| P140 | | | | | |
| ARKON | 24.4 | 24.4 | 24.4 | 24.4 | 24.4 |
| M100 | | | | | |

For Examples 1 and 3 to 14, before adding it to the spray container, the pH of the emulsion was adjusted with aqueous ammonia (i.e., NH₄OH) to obtain the pH indicted in Tables 4 and 5, below.

TABLE 4
Spray and Adhesion Data for Examples 1-9 applied by Air-Assisted Spray Method

| Example | 1 | 2 | 3 | 4 | 5 | 6 | 7 | 8 | 9 |
|---|---|---|---|---|---|---|---|---|---|
| pH | 3.5 | 3 | 3.5 | 3.5 | 3.5 | 4 | 3.5 | 3.5 | 3.5 |
| Time to | <1 min | <1 min | <1 min | <1 min | <1 min | <1 min | <1 min | <1 min | <1 min |
| Hold | | | | | | | | | |
| Birch/Birch | 1.01 MPa | 0.95 MPa | 0.97 MPa | 1.22 MPa | 1.42 MPa | 0.45 MPa | 1.03 MPa | 1.32 MPa | 1.28 MPa |
| Overlap | | | | | | | | | |
| Shear | | | | | | | | | |
| Birch/PP | 0.83 MPa | 0.81 MPa | 0.87 MPa | 1.25 MPa | 1.43 MPa | 0.75 MPa | 0.83 MPa | 1.10 MPa | 1.29 MPa |
| Overlap | | | | | | | | | |
| Shear | | | | | | | | | |
| SAFT | 66° C. | 66° C. | 66° C. | 71° C. | 77° C. | 82° C. | 149° C. | 116° C. | 149° C. |
| Woven | 9.8 | 10.7 | 12.0 | 14.7 | 16.0 | 17.8 | 20.5 | 16.0 | 16.5 |
| Geotextile | N/25 | N/25 | N/25 | N/25 | N/25 | N/25 | N/25 | N/25 | N/25 |
| Peel | mm | mm | mm | mm | mm | mm | mm | mm | mm |
| Nonwoven | 15.6 | 16.0 | 16.5 | 41.8 | 51.6 | 40.9 | 27.6 | 30.3 | 52.1 |
| Geotextile | N/25 | N/25 | N/25 | N/25 | N/25 | N/25 | N/25 | N/25 | N/25 |
| Peel | mm | mm | mm | mm | mm | mm | mm | mm | mm |
| Woven | 0.05 MPa | 0.04 MPa | 0.04 MPa | 0.08 MPa | 0.09 MPa | 0.14 MPa | 0.21 MPa | 0.20 MPa | 0.21 MPa |
| Geotextile | | | | | | | | | |
| Overlap | | | | | | | | | |
| Shear | | | | | | | | | |
| Nonwoven | 0.05 MPa | 0.06 MPa | 0.06 MPa | 0.21 MPa | 0.26 MPa | 0.19 MPa | 0.15 MPa | 0.20 MPa | 0.27 MPa |
| Geotextile | | | | | | | | | |
| Overlap | | | | | | | | | |
| Shear | | | | | | | | | |

TABLE 5
Spray and Adhesion Examples 10-14

| | | | | | | Comparative |
|---|---|---|---|---|---|---|
| Example | 10 | 11 | 12 | 13 | 14 | Example 1 |
| Spray Method | Air | Airless | Airless | Airless | Airless | Air |
| | Assist | | | | | Assist |
| pH | 3.5 | 9 | 8.5 | 4.5 | 7 | 3 |
| Time to Hold | <1 min | <1 min | <1 min | <1 min | <1 min | 5 min |
| Birch/Birch | 1.15 MPa | 1.59 MPa | 1.42 MPa | 1.23 MPa | 1.23 MPa | 1.52 MPa |
| Overlap | | | | | | |
| Shear | | | | | | |
| Birch/Polypropylene | 0.73 MPa | 1.17 MPa | 1.20 MPa | 1.03 MPa | 0.92 MPa | 1.30 MPa |
| Overlap | | | | | | |
| Shear | | | | | | |
| SAFT | 104° C. | 138° C. | 149° C. | 143° C. | 138° C. | 149° C. |
| Woven | 13.3 | 14.2 | 13.8 | 19.1 | 18.7 | Not |
| Geotextile | N/25 | N/25 | N/25 | N/25 | N/25 | tested |
| Peel | mm | mm | mm | mm | mm | |
| Nonwoven | 39.2 | 30.3 | 37.8 | 27.1 | 25.4 | Not |
| Geotextile | N/25 | N/25 | N/25 | N/25 | N/25 | tested |
| Peel | mm | mm | mm | mm | mm | |
| Woven | 0.22 MPa | 0.24 MPa | 0.31 MPa | 0.20 MPa | 0.29 MPa | Not |
| Geotextile | | | | | | tested |
| Overlap Shear | | | | | | |
| Nonwoven | 0.45 MPa | 0.37 MPa | 0.42 MPa | 0.32 MPa | 0.35 MPa | Not |
| Geotextile | | | | | | tested |
| Overlap Shear | | | | | | |
| Instant Tack- | Pass | Pass | Pass | Pass | Pass | Fail |
| and-Hold Test | | | | | | |

This disclosure is not limited to the above-described embodiments but is to be controlled by the limitations set forth in the following claims and any equivalents thereof. This disclosure may be suitably practiced in the absence of any element not specifically disclosed herein.

1. A composition comprising:
an acrylic polymer comprising monomer units of at least one of an alkyl acrylate or alkyl methacrylate, wherein alkyl has at least 8 carbon atoms, and less than one percent by weight of monomer units comprising a carboxylic acid, sulfonic acid, or phosphonic acid, based on the total weight of monomer units in the acrylic polymer;
a tackifier;
an emulsifier; and
water,
wherein the composition is an emulsion of the acrylic polymer in water, and wherein the composition is a spray adhesive composition, or coagulates upon being subjected to shear forces to form a pressure-sensitive adhesive, or is a spray adhesive composition that coagulates upon spraying.

2. The composition of claim 1, wherein alkyl has at least 10 carbon atoms.

3. The composition of claim 1, wherein the acrylic polymer further comprises monomer units of a second monomer comprising at least one of a C₄-C₉ alkyl acrylate or C₄-C₉ alkyl methacrylate.

4. The composition of claim 1, wherein the acrylic polymer further comprises monomer units of a high T_{g} monomer that when polymerized provides a homopolymer having a glass transition temperature of at least 40° C.

5. The composition of claim 1, wherein the acrylic polymer further comprises monomer units of a polar monomer including at least one ketone, amide, amine, alcohol, or a combination thereof.

6. The composition of claim 1, wherein the acrylic polymer further comprises monomer units of an acrylate or methacrylate having more than one acrylate or methacrylate group.

7. The composition of claim 1, wherein the acrylic polymer is a nonionic polymer.

8. The composition of claim 1, further comprising a base.

9. The composition of claim 1, wherein the emulsion is substantially free of thermoplastic microspheres containing a blowing agent.

10. The composition of claim 1, packaged in a spray container.

11. The composition of claim 1, wherein the tackifier is a hydrocarbon tackifier.

12. The composition of claim 1, wherein the emulsion comprises droplets comprising both the tackifier and the acrylic polymer.

13. A process for making the composition of claim 1, the method comprising:
combining the at least one tackifier and the at least one of an alkyl acrylate or alkyl methacrylate to form a solution;
combining the solution with the water and the emulsifier; and
polymerizing the at least one of an alkyl acrylate or alkyl methacrylate to form an emulsion with droplets that include both the acrylic polymer and the tackifier.

14. A method of making a bonded article comprising a first substrate and a second substrate, the method comprising:
spraying the composition of claim 1 on at least one of the first substrate or the second substrate; and
adhering the first substrate and the second substrate using the emulsion.

15. The method of claim 14, wherein the composition coagulates upon spraying.

16. The method of claim 14, wherein the adhesive is tacky within one minute after spraying.

17. The method of claim 14, wherein at least one of the first substrate or the second substrate is a nonwoven or woven fabric.

18. The composition of claim 1, wherein the tackifier is present in the composition in a range from two parts to 30 parts per one hundred parts of acrylic polymer.

19. The composition of claim 1, wherein the emulsion coagulates upon being sprayed.

20. The composition of claim 1, wherein the acrylic polymer is not a core-shell polymer.
